(19) United States
(12) Patent Application Publication
(10) Pub. No.: US 2010/0262774 A1
(43) Pub. Date: Oct. 14, 2010

(54) STORAGE CONTROL APPARATUS AND STORAGE SYSTEM

(75) Inventors: Kosuke UCHIDA, Kawasaki (JP); Yasuo Noguchi, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/751,289

(22) Filed: Mar. 31, 2010

(30) Foreign Application Priority Data
Apr. 14, 2009 (JP) 2009-97917

(51) Int. Cl. G06F 12/00; G06F 15/167

(52) U.S. Cl. 711/114; 709/214; 711/E12.001

(57) ABSTRACT

A storage control apparatus is provided. The storage control apparatus reads from and writes to a plurality of storages of a storage system including a plurality of servers and a control server that sets storage areas available to one of the plurality of servers from among the storage areas of the plurality of storages sharable among the plurality of servers. The apparatus includes a first acquisition unit that acquires, for each of the storages, an index about the distance between the control server and the storage, a second acquisition unit that acquires, for each of the storage areas in the storages, an index about a writing speed to the storage area, and a calculation unit that calculates, for each of the storage areas, a general index indicating the quality of the storage area based on the indexes acquired by the first acquisition unit and second acquisition unit.

### CROSS-REFERENCE TO RELATED APPLICATION(S)

This application is related to and claims priority to Japanese Patent Application No. 2009-097917 filed on Apr. 14, 2009, incorporated herein by reference.

### BACKGROUND

1. Field

The embodiments discussed herein are directed to a storage control apparatus, a storage system, and a computer-readable recording medium that stores a storage control program for controlling the storage thereof.

2. Description of the Related Art

Disclosed in the related art is a technology for checking whether the operating status of a RAID group satisfies a set required value (set based on a contract etc. with a customer), and if it does not satisfy the required value, satisfying the required value by moving a logical volume included in the RAID group to another RAID group (for example, Japanese Laid-open Patent Publication No. 2002-182859).

### SUMMARY

It is an aspect of the embodiments discusses herein to provide a storage control apparatus, a storage system, and a computer-readable recording medium that stores a storage control program for controlling the storage thereof.

The above aspects can be attained by a storage control apparatus configured to read from and write to a plurality of storages of a storage system including a plurality of servers and a control server that sets storage areas available to one of the plurality of servers from among the storage areas of the plurality of storages sharable among the plurality of servers, the apparatus includes, a first acquisition unit that acquires, for each of the storages, an index about the distance between the control server and the storage, a second acquisition unit that acquires, for each of the storage areas in the storages, an index about a writing speed to the storage area, and a calculation unit that calculates, for each of the storage areas, a general index indicating the quality of the storage area based on the indexes acquired by the first acquisition unit and second acquisition unit.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF DRAWINGS

FIG. 1 illustrates a storage system;

FIG. 2 illustrates memory contents of a contract level table;

FIG. 3 illustrates scores (distance, performance, and frequency of use) used as a reference;

FIG. 4 illustrates a computer according to an embodiment;

FIG. 5 illustrates memory contents of a quality control table;

FIG. 6 illustrates a quality evaluation sequence;

FIG. 7 illustrates memory contents of a quality-general index correlation table;

FIG. 8 illustrates the state of slices after quality evaluation;

FIG. 9 illustrates a slice assignment sequence;

FIG. 10 illustrates memory contents of a quality control table after the assignment according to the slice assignment sequence of FIG. 9;

FIG. 11 illustrates a state of the slices after the slice assignment; and

FIG. 12 illustrates a storage system.

### DESCRIPTION OF THE EMBODIMENTS

To assign a slice corresponding to a contract level of a required quality, a general index may be obtained that takes into account a distance from a control node, the performance of a disk node that reads from and writes to the slice, and the frequency of use of the slice, and the quality of the slice is evaluated according to the obtained general index. Thus, automatic assignment of a slice corresponding to required quality may be achieved.

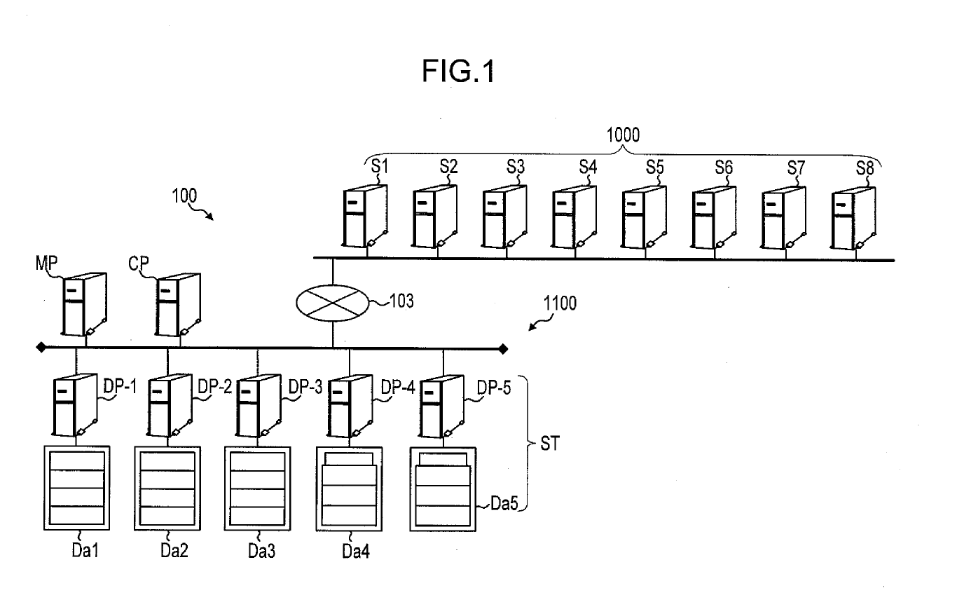

FIG. 1 illustrates a storage system. The storage system 100 includes a data center 101 and an operation server group 1000. The components in the storage system 100 are connected so as to communicate with one another via a network 103, such as a LAN (local area network), a WAN (wide area network), or the Internet.

The data center 101 is a system that provides the operation server group 1000 with a storage service. The storage service is a computer process that provides the operation server group 1000 with reading and writing of data. The data center 101 includes a management node MP, a control node CP, and a storage unit group 1100. The management node MP is a computer that manages operation servers S1 to S8 to which the service is to be provided. The control node CP is a computer that manages the disk areas of all physical disks D in a unified manner.

The storage unit group 1100 includes disk nodes DP-1 to DP-5 and physical disks Da1 to Da5 connected thereto, respectively. The disk nodes DP-1 to DP-5 are computers that read and write data from and to the physical disks Da1 to Da5 under the control of the control node CP. The physical disks Da1 to Da5 are hard disks, nonvolatile memories, or magnetic tapes.

The physical disks Da1 to Da5 assign disk areas to operation servers Sk (k is any number) in the unit called slice SLij(Sk). In this specification, “i” of a slice SLij( )indicates the number of the end of the disk nodes DP-1 to DP-5; and “j” indicates the location of the slice SLij( ) Bracket “( )” is given an assigned operation server name (Sk), which is omitted if no operation server is assigned.

Slices SLij(Sk) assigned to a certain operation server Sk span the plurality of physical disks Da1 to Da5. However, the physical disks Da1 to Da5 appear if they are a single physical disk as seen from the individual operation servers Sk. Thus, the disk areas of all the physical disks Da1 to Da5 are virtual areas (or virtual disks).

The operation servers Sk are computers that receive a storage assignment service from the data center 101. The operation servers Sk may read data stored in the virtual areas or write data to the virtual areas. The operation servers Sk access the slices in the physical disks Da1 to Da5 of the disk nodes DP-1 to DP-5 assigned to the operation servers Sk, and read and write data.

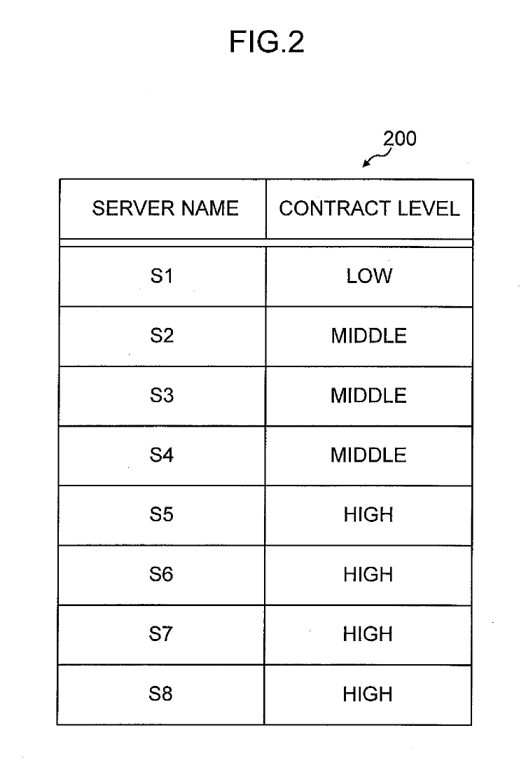

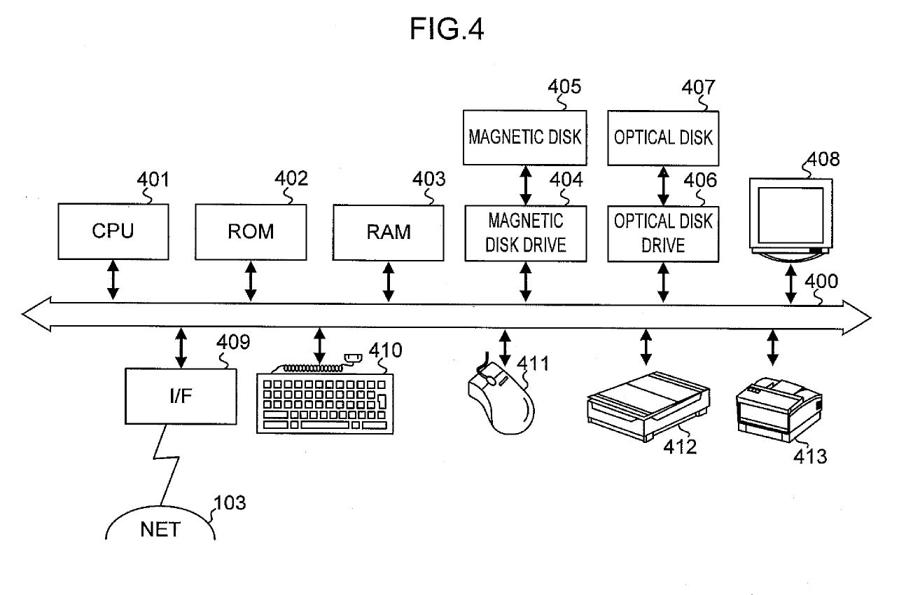

FIG. 2 illustrates memory contents of a contract level table. The contract level table 200 may use a storage medium illustrated in FIG. 4, such as a ROM 402, a RAM 403, or a magnetic disk 405. The contract level is a quality of a storage service and may be set for the individual operation servers Sk. FIG. 2 uses three levels, “high”, “middle”, and “low”, of which “high” is the highest level and “low” is the lowest level.

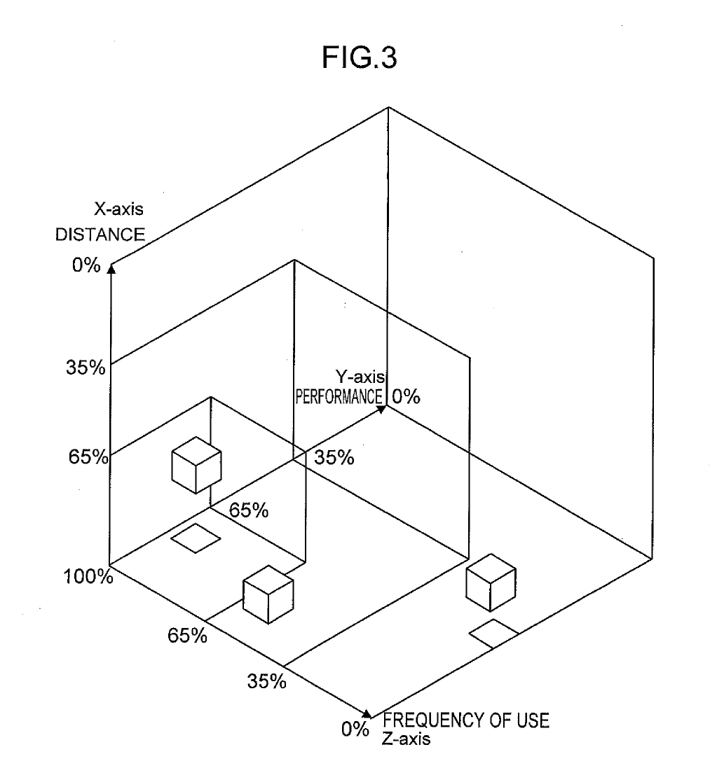

FIG. 3 illustrates three kinds of scores (distance, performance, and frequency of use) used as the reference. The X-axis indicates scores when the distance from the management node MP to the slice SLij is used as the reference. This shows that the higher the percentage, the shorter the distance is.

The Y-axis indicates scores when the performance of a disk node DP-i is used as the reference. The performance indicates a writing speed to a slice SLij. This shows that the higher the percentage, the higher the performance is, that is, the higher the writing speed to a physical disk Dai is.

The Z-axis indicates scores when the frequency of use of a slice SLij is used as the reference. This shows that the higher the percentage, the less the slice SLij is used.

FIG. 4 illustrates a computer according to an embodiment. In FIG. 4, the computer includes a CPU (central processing unit) 401, the ROM (read-only memory) 402, the RAM (random access memory) 403, a magnetic disk drive 404, the magnetic disk 405, an optical disk drive 406, an optical disk 407, a display 408, an I/F (Interface) 409, a keyboard 410, a mouse 411, a scanner 412, and a printer 413. The components may be connected to one another with a bus 400.

According to an embodiment, CPU 401 controls the entire computer. The ROM 402 stores programs including a boot program. The RAM 403 is used as a work area of the CPU 401. The magnetic disk drive 404 controls the read/write of data from/to the magnetic disk 405 according to the control of the CPU 401. The magnetic disk 405 stores data written under the control of the magnetic disk drive 404.

The optical disk drive 406 controls the read/write of data from/to the optical disk 407 according to the control of the CPU 401. The optical disk 407 stores data written under the control of the optical disk drive 406 or causes the computer to read data stored in the optical disk 407.

The display 408 displays a cursor, icons, and a toolbox, as well as data, such as documents, images, and functional information. The display 408 may be, for example, a CRT display, a TFT liquid-crystal display, or a plasma display.

The interface (hereinafter abbreviated to “I/F”) 409 is connected to the network 103, such as a LAN (local area network), a WAN (wide area network), or the Internet, over a communication line and is connected to other devices via the network 103. The I/F 409 interfaces between the network 103 and the inside to control the input and output of data to/from the external devices. The I/F 409 may be, for example, a modem or a LAN adapter.

The keyboard 410 has keys for inputting characters, numerals, various instructions, etc. and is used to input data. Instead, a touch-panel input pad or a numeric keypad may be used. The mouse 411 is used to move a cursor, specify the range, move the window, or change the size. Instead, a trackball or a joystick having the same function may be used as a pointing device.

The scanner 412 optically reads an image and captures the image data into the computer. The scanner 412 may also have an OCR (optical character reader) function. The printer 413 prints image data or document data. The printer 413 may be a laser printer or an inkjet printer.

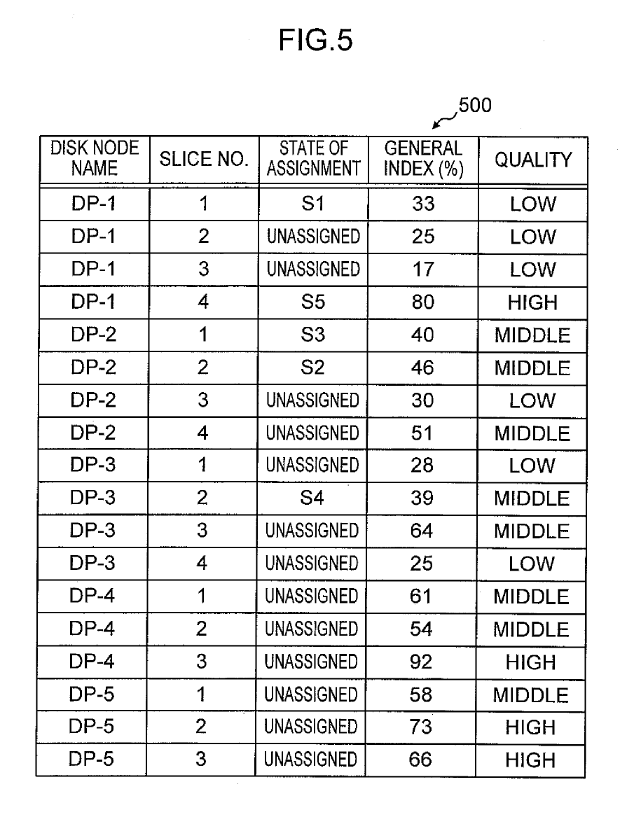

FIG. 5 illustrates memory contents of a quality control table. The quality control table 500 performs its function using the storage medium illustrated in FIG. 4, such as the ROM 402, the RAM 403, or the magnetic disk 405.

The quality control table 500 may be held by the control node CP and manages the quality of the slices SLij. The quality control table 500 stores the disk node name, the slice number, the state of assignment, the general index, and the quality of each slice SLij. The general index Gij is an index calculated for each slice SLij based on three kinds of scores (distance, performance, and frequency of use) according to a quality evaluation program. The quality is the contract level illustrated in FIG. 2.

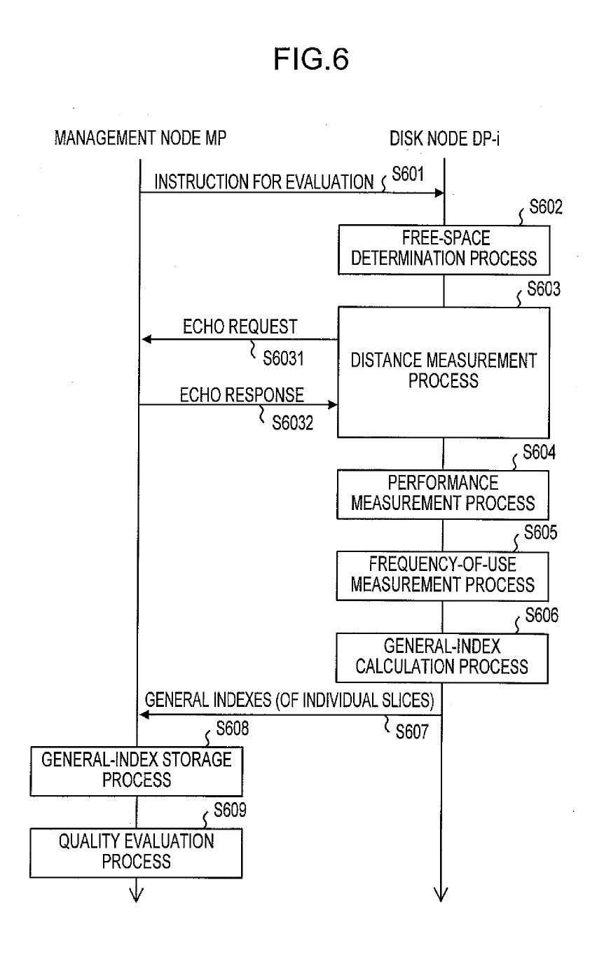

FIG. 6 illustrates a quality evaluation sequence. The management node MP transmits an instruction to evaluate the quality to a disk node DP-i (operation S601). On receiving the instruction for evaluation, the disk node DP-i executes a free-space determination process (operation S602). In the free-space determination process (operation S602), the disk node DP-i detects the free space of an accessible disk Dai.

The disk node DP-i determines whether the detected free space is greater than or equal to a predetermined free space. If the free space is greater than or equal to the predetermined free space, the slices SLij in the physical disk Dai are determined to be evaluated, and if the free space is smaller than the predetermined free space, the slices SLij in the physical disk Dai are determined not to be evaluated.

The disk node DP-i executes a distance measurement process (operation S603). The distance measurement process (operation S603) is the process of measuring the distance between the management node MP and the disk node DP-i. The disk node DP-i transmits an echo request to the management node MP using, for example, a ping (packet internet grouper) command (operation S6031). On receiving the echo request, the management node MP returns an echo response to the disk node DP-i (operation S6032).

In the distance measurement process (operation S603), the disk node DP-i acquires the time t [msec] from the transmission of the echo request to the reception of the echo response. The disk node DP-i calculates an index g1 [%] about the distance from the obtained time t [msec] using Eq. (1):

g1=100−t (1).

After the distance measurement process (operation S603), the disk node DP-i executes a performance measurement process (operation S604). The performance measurement process (operation S604) is the process of measuring the writing speed of the disk node DP-i to the slices SLij. Slices SLij not to be evaluated are not measured. The writing speed s [MB/sec] may be held in the disk node DP-i in advance, or alternatively, speeds that are measured when the disk node DP-i wrote or the mean value thereof may be used. In the performance measurement process (operation S604), the disk node DP-i calculates an index g2 [%] about the performance using Eq. (2):

g2=s (2).

After the performance measurement process (operation S604), the disk node DP-i executes a frequency-of-use measurement process (operation S605). This process is not performed on the slices SLij not to be evaluated and unused slices SLij. In the frequency-of-use measurement process (operation S605), the frequencies of use of the slices SLij are measured.

For example, every time reading and writing to the slices SLij is executed, the disk node DP-i measures the number of times of reading and writing and the time required for the reading and writing and stores them. The disk node DP-i then calculates the number u [iops] of times of reading and writing per one second from the sum of the stored number of times of reading and writing and the sum of the stored time required for the reading and writing. In the frequency-of-use measurement process (operation S605), the disk node DP-i calculates an index g3 [%] about the frequency of use using Eq. (3):

g3 =(1000−u)/10 (3).

After the frequency-of-use measurement process (operation S605), the disk node DP-i executes a general-index calculation process (operation S606). In the general-index calculation process (operation S606), the disk node DP-i calculates the general indexes Gij of the slices SLij from Eq. (4) using the thus-calculated indexes g1 to g3.

Gij=(g1×g2×g3)/10000 (4).

For unused slices SLij, the general indexes Gij of the slices SLij are calculated from Eq. (5) using the indexes g1 and g2.

Gij=(g1×g2)/100 (5).

After execution of the general-index calculation process (operation S606), the disk node DP-i transmits the general indexes Gij of the individual slices SLij to the management node MP (operation S607). On receiving the general indexes Gij, the management node MP executes a general-index storage process (operation S608). In the general-index storage process (operation S608), the management node MP writes the received general indexes Gij to the item of the general index on the record of the slices SLij on the quality control table 500.

The management node MP executes a quality evaluation process (operation S609). In the quality evaluation process (operation S609), the management node MP evaluates the quality of the slices SLij using the quality-general index correlation table that shows the correlation between quality and the general index Gij.

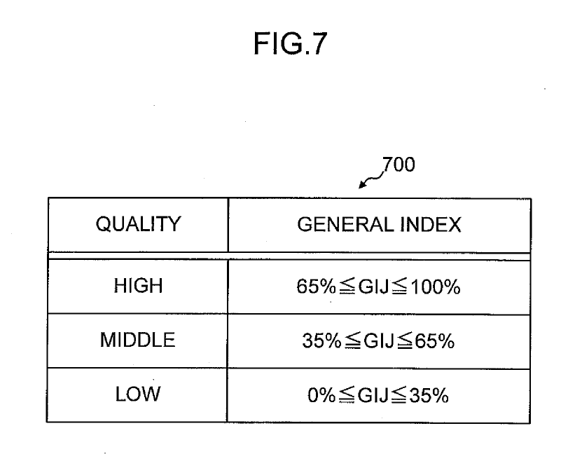

FIG. 7 illustrates the memory contents of the quality-general index correlation table. The quality-general index correlation table 700 uses a storage medium illustrated in FIG. 4, such as the ROM 402, the RAM 403, or the magnetic disk 405. The quality is “contract level” illustrated in FIG. 2. The general index Gij is an index calculated for each slice SLij based on the three kinds of indexes (distance, performance, and frequency of use). As illustrated in FIG. 7, the higher the index, the higher the quality of the contract level is.

The quality (high, middle, or low) of each slice SLij may be determined by referring to the quality-general index correlation table 700. In the quality evaluation process (operation S609), the management node MP writes quality information (high, middle, or low) read from the quality-general index correlation table 700 to the item of quality on the record of the slices SLij on the quality control table 500. Thus, the quality of each slice SLij may be determined as illustrated in FIG. 3.

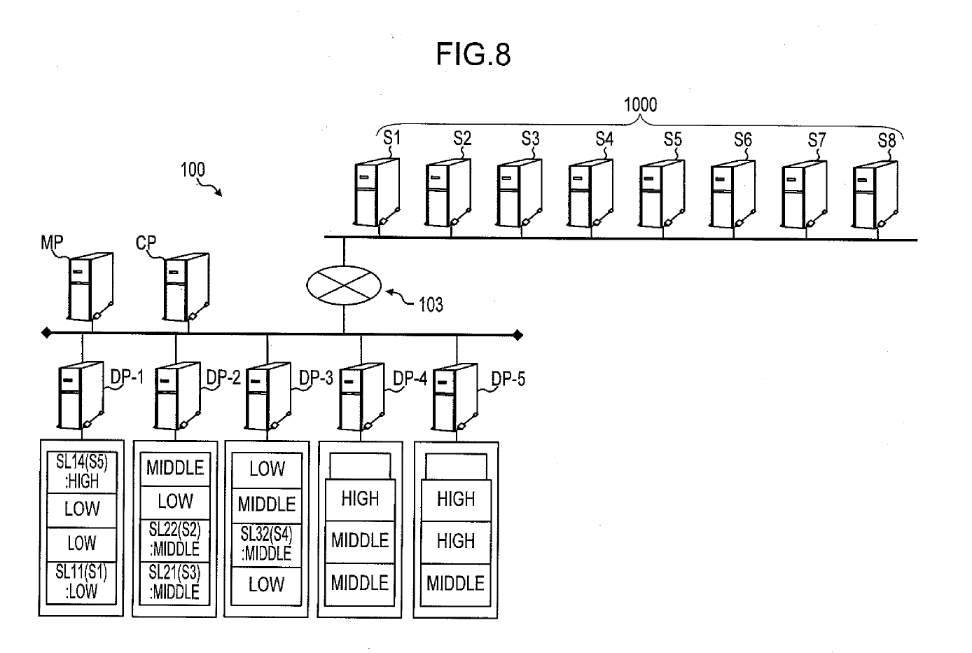

FIG. 8 illustrates a state of the slices SLij after the quality evaluation. By executing the quality evaluation sequence illustrated in FIG. 6, the quality of the slices SLij may be determined.

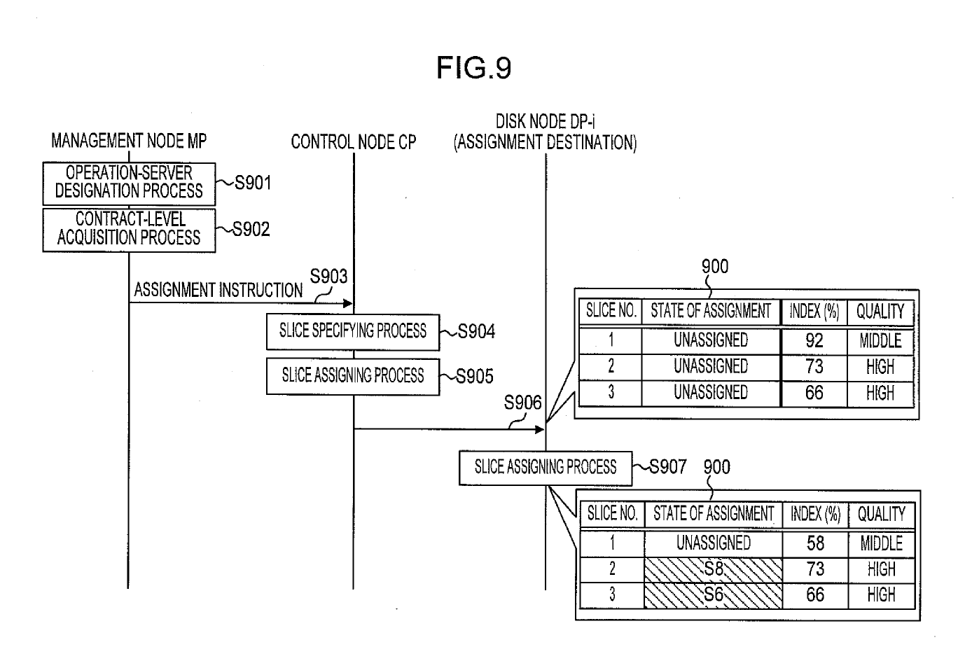

FIG. 9 illustrates a slice assignment sequence. The management node MP designates an operation server Sk by an operation server designation process (operation S901) and acquires the contract level of the designated operation server Sk by a contract-level acquisition process (operation S902).

The contract level may be acquired by either receiving a manipulation input of the management node MP or receiving the contract level from the operation server Sk. In either case, upon acquisition of the contract level of the designated operation server Sk, the management node MP gives the control node CP an assignment instruction (operation S903). The assignment instruction includes the operation server name of the designated operation server Sk and its contract level.

Upon reception of the assignment instruction, the control node CP executes a slice specifying process (operation S904). The slice specifying process (operation S904) is the process of specifying slices SLij corresponding to the contract level of the designated operation server Sk. The control node CP accesses the quality control table 500 to detect unassigned slices SLij of the same quality.

Referring to FIG. 5, for example, if the contract level of the designated operation server Sk is “high”, the control node CP detects records in which the item of quality is “high”. Slices of “high” are SL14, SL43, SL52, and SL53. Among them, the slice S14 has already been assigned to the operation server S5; therefore, the target slices are narrowed down to SL43, SL52, and SL53.

After the slice specifying process (operation S904), the control node CP executes a slice assigning process (operation S905). In the slice assigning process of the control node CP (operation S905), the control node CP writes the name of an operation server Sk that is an assignment destination to the item of the assignment state on the record of the specified slices SLij on the quality control table 500 illustrated in FIG. 5.

For example, if the designated operation server Sk is an operation server S6, the contract level of the operation server S6 may be determined to be “high” with reference to the contract level table 200. Accordingly, the control node CP assigns a desired slice SL53 as a logical disk, from among the slices SL43, SL52, and SL53 whose quality is “high”, to the operation server S6. The control node CP transmits the result of assignment to the disk node DP-i (operation S906).

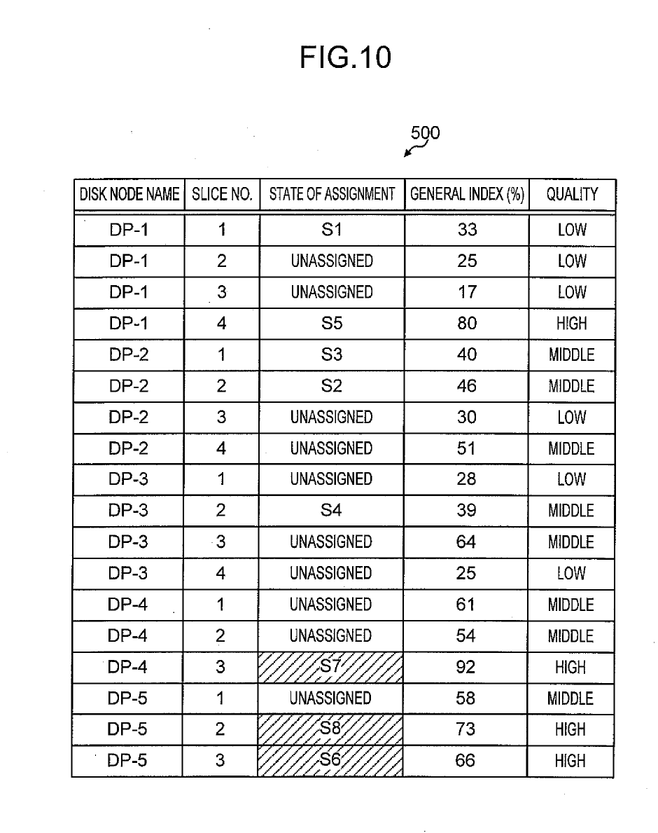

FIG. 10 illustrates memory contents of the quality control table 500 after the assignment according to the slice assignment sequence of FIG. 9. The hatched items in FIG. 10 are portions to which operation server names are newly written.

Referring back to FIG. 9, upon receiving the assignment result from the control node CP, the disk node DP-i executes a slice assigning process (operation S907). The slice assigning process (operation S907) of the disk node DP-i is a process for synchronizing with the quality control table 500 and updates an inner control table 900 held in the disk node DP-i.

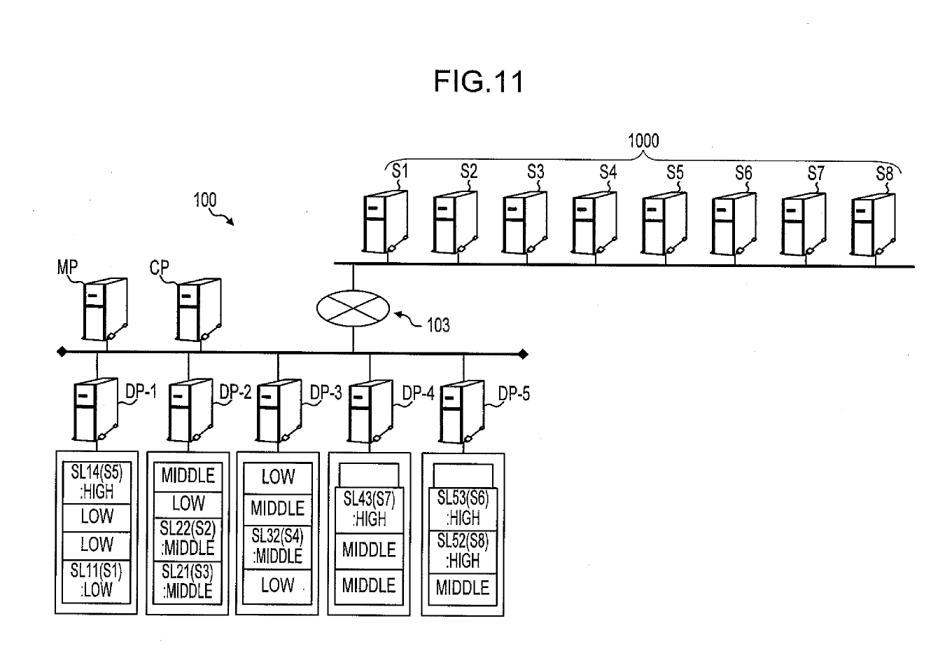

FIG. 11 illustrates the state of the slices SLij after the slice assignment. By executing the slice assignment sequence illustrated in FIG. 9, the slices SL43, SL52, and SL53 that were unassigned in the state of FIG. 6 are assigned operation servers S6 to S8.

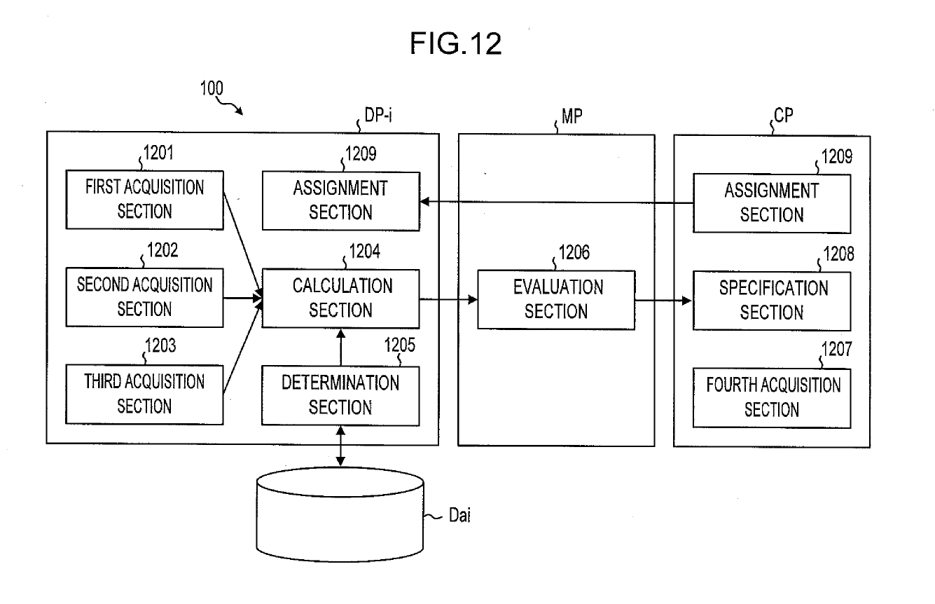

FIG. 12 illustrates a storage system 100. In FIG. 12, the storage system 100 includes a first acquisition section 1201, a second acquisition section 1202, a third acquisition section 1203, a calculation section 1204, a determination section 1205, an evaluation section 1206, a fourth acquisition section 1207, a specification section 1208, and an assignment section 1209.

The Control (the first acquisition section 1201 through the assignment section 1209) may be achieved by causing the CPU 401 to execute programs stored in the storage medium illustrated in FIG. 4, such as the ROM 402, the RAM 403, the magnetic disk 405, or the optical disk 407, or via the I/F 409.

The first acquisition section 1201 through the determination section 1205 may be accomplished by the disk node DP-i; the evaluation section 1206 may be accomplished by the management node MP (or the control node CP; and the fourth acquisition section 1207 through the assignment section 1209 may be accomplished by the control node CP.

The first acquisition section 1201 acquires indexes about the distances between the individual storages and the control server. For example, the first acquisition section 1201 calculates indexes g1 about the distances between the control node CP and the individual disk nodes DP-i. The first acquisition section 1201 corresponds to the distance measurement process (operation S603) illustrated in FIG. 6.

The second acquisition section 1202 acquires indexes about writing speeds to the individual storage areas in the storage. For example, the second acquisition section 1202 acquires indexes g2 about writing speeds to the individual slices SLij in the disk node DP-i. The second acquisition section 1202 corresponds to the performance measurement process (operation S604) illustrated in FIG. 6.

The third acquisition section 1203 acquires indexes about the frequency of use of the individual storage areas in the storage. For example, the third acquisition section 1203 acquires indexes g3 about the frequency of use of the individual slices SLij in the disk node DP-i. The third acquisition section 1203 corresponds to the frequency-of-use measurement process (operation S605) illustrated in FIG. 6.

The calculation section 1204 calculates general indexes indicating the quality of the individual storage areas based on the indexes acquired by at least the first and second acquisition sections 1201 and 1202. For example, the calculation section 1204 calculates general indexes Gij indicating the quality of the slices SLij using for example, at least the indexes g1 and g2 of the indexes g1 to g3. If the index g3 is acquired by the third acquisition section 1203, the calculation section 1204 calculates the general index Gij also using the index g3. The calculation section 1204 corresponds to the general-index calculation process (operation S606) illustrated in FIG. 6.

The determination section 1205 has the function of determining whether the free spaces of the individual storage areas are greater than or equal to a predetermined free space. For example, the determination section 1205 determines whether the free spaces of the individual disks Dai are greater than or equal to a predetermined free space. If the free space falls below the predetermined free space, the calculation section 1204 unconditionally determines that the general index of the slice SLij in the physical disk Dai is 0[%].

If the free space is greater than or equal to the predetermined free space, the general index Gij is calculated by the calculation section 1204. This may decrease the preference of assignment by determining the tight-space slices SLij in the physical disk Dai to be of low quality. The determination section 1205 corresponds to the free-space determination process (operation S602) illustrated in FIG. 6.

The evaluation section 1206 has the function of evaluating the quality of the individual storage areas in accordance with the general indexes calculated by the calculation section 1204. For example, the evaluation section 1206 evaluates the quality of the individual slices SLij in accordance with the general indexes Gij. The evaluation section 1206 corresponds to the general-index storage process (operation S608) and the quality evaluation process (operation S609) illustrated in FIG. 6.

The fourth acquisition section 1207 acquires quality that a specific server selected from a plurality of servers. For example, the fourth acquisition section 1207 reads quality required by a specific operation server Sk selected from the operation server group 1000 from the contract level table 200. The fourth acquisition section 1207 corresponds to the operation-server designation process (operation S901) and the contract-level acquisition process (operation S902) illustrated in FIG. 9.

The specification section 1208 specifies an unassigned storage area of the same quality as that acquired by the fourth acquisition section 1207 based on the quality evaluated by the evaluation section 1206. For example, the specification section 1208 detects, from the quality control table 500, slices SLij having required quality and not assigned to any operation server Sk among the slices SLij whose quality was evaluated by the evaluation section 1206. The specification section 1208 corresponds to the slice specifying process (operation S904) illustrated in FIG. 9.

The assignment section 1209 in the control node CP assigns the storage areas specified by the specification section 1208 to a specific server. For example, the assignment section 1209 assigns slices SLij specified by the specification section 1208, that is, unassigned slices SLij of the same quality as the required quality to a specific operation server Sk selected from the operation server group 1000. The assignment section 1209 corresponds to the slice assigning process (operation S905) of the control node CP illustrated in FIG. 9.

The assignment section 1209 executes the same assignment process also in the disk node DP-i. The assignment section 1209 executes the slice assigning process (operation S907) of the disk node DP-i illustrated in FIG. 9.

When assigning a data storage area by the storage system, an access speed from the control node CP may be taken into account by using the index g1 about the distance as a factor for calculating the general index Gij. The use of the index g2 about the performance allows an access speed from the disk node DP-i to be taken into account.

Furthermore, the use of the index g3 about the frequency of use allows the freshness, durability, and degradation of the slices SLij to be taken into account. Moreover, taking account of the free space of the entire disk Da may decrease the preference of assignment of tight-space physical disks Dai and allows assignment from another disk Da.

The use of the general index Gij in which the plurality of kinds of indexes g1 to g3 are taken into account allows automatic determination of an optimum assignment destination according to the contract level of the operation server Sk. Thus, by assigning to the determined assignment destination, an optimum storage service corresponding to the contract level may be provided to the operation server Sk.

The storage control method according to an embodiment may be achieved by executing a prepared program by a computer, such as a personal computer or a workstation. The storage control method may be distributed via a network, such as the Internet.

The embodiments can be implemented in computing hardware (computing apparatus) and/or software, such as (in a non-limiting example) any computer that can store, retrieve, process and/or output data and/or communicate with other computers. The results produced can be displayed on a display of the computing hardware. A program/software implementing the embodiments may be recorded on non-transitory computer-readable media comprising computer-readable recording media. Examples of the computer-readable recording media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW.

Further, according to an aspect of the embodiments, any combinations of the described features, functions and/or operations can be provided.

The many features and advantages of the embodiments are apparent from the detailed specification and, thus, it is intended by the appended claims to cover all such features and advantages of the embodiments that fall within the true spirit and scope thereof. Further, since numerous modifications and changes will readily occur to those skilled in the art, it is not desired to limit the inventive embodiments to the exact construction and operation illustrated and described, and accordingly all suitable modifications and equivalents may be resorted to, falling within the scope thereof.

What is claimed is:

1. A storage control apparatus configured to read from and write to a plurality of storages of a storage system including a plurality of servers and a control server that sets storage areas available to one of the plurality of servers from among the storage areas of the plurality of storages sharable among the plurality of servers, the apparatus comprising:
a first acquisition unit that acquires, for each of the storages, an index about the distance between the control server and the storage;
a second acquisition unit that acquires, for each of the storage areas in the storages, an index about a writing speed to the storage area; and
a calculation unit that calculates, for each of the storage areas, a general index indicating the quality of the storage area based on the indexes acquired by the first acquisition unit and second acquisition unit.

2. The apparatus according to claim 1, further comprising:
a third acquisition unit that acquires, for each of the storage areas in the storages, an index about the frequency of use of the storage area,
wherein the calculation unit calculates, for each of the storage areas, a general index indicating the quality of the storage area based on the indexes acquired by the first acquisition unit, the second acquisition unit, and the third acquisition unit.

3. The apparatus according to claim 1 further comprising:
a determination unit that determines, for each of the storage areas, whether the free space thereof is greater than or equal to a predetermined free space,
wherein the calculation unit calculates a general index indicating the quality of a storage area that may be determined to have a free space greater than or equal to the predetermined free space.

4. The apparatus according to claim 2 further comprising:
a determination unit that determines, for each of the storage areas, whether the free space thereof is greater than or equal to a predetermined free space,
wherein the calculation unit calculates a general index indicating the quality of a storage area that may be determined to have a free space greater than or equal to the predetermined free space.

5. The apparatus according to claim 1 further comprising:
an evaluation unit that evaluates, for each of the storage areas, quality corresponding to the general index calculated by the calculation unit.

6. The apparatus according to claim 2 further comprising:
an evaluation unit that evaluates, for each of the storage areas, quality corresponding to the general index calculated by the calculation unit.

7. The apparatus according to claim 3 further comprising:
an evaluation unit that evaluates, for each of the storage areas, quality corresponding to the general index calculated by the calculation unit.

8. The apparatus according to claim 5 further comprising:
a fourth acquisition unit that acquires quality required by a specific server selected from the plurality of servers;
a specification unit that specifies an unassigned storage area of the same quality as the quality acquired by the fourth acquisition unit based on the quality evaluated by the evaluation unit; and
an assignment unit that assigns the storage area specified by the specification unit to the specific server.

9. The apparatus according to claim 6 further comprising:
a fourth acquisition unit that acquires quality required by a specific server selected from the plurality of servers;
a specification unit that specifies an unassigned storage area of the same quality as the quality acquired by the fourth acquisition unit based on the quality evaluated by the evaluation unit; and
an assignment unit that assigns the storage area specified by the specification unit to the specific server.

10. A storage system including a plurality of servers and a control server that sets storage areas available to one of the plurality of servers from among the storage areas of a plurality of storages sharable among the plurality of servers, the system comprising:
a first acquisition unit that acquires, for each of the storages, an index about the distance between the control server and the storage;
a second acquisition unit that acquires, for each of the storage areas in the storages, an index about a writing speed to the storage area;
a calculation unit that calculates, for each of the storage areas, a general index indicating the quality of the storage area based on the indexes acquired by the first unit and second acquisition unit;
an evaluation unit that evaluates, for each of the storage areas, quality corresponding to the general index calculated by the calculation unit;
a fourth acquisition unit that acquires quality required by a specific server selected from the plurality of servers;
a specification unit that specifies an unassigned storage area of the same quality as the quality acquired by the fourth acquisition unit; and
an assignment unit that assigns the storage area specified by the specification unit to the specific server.

11. A computer-readable recording medium that stores a storage control program for a computer that constitutes a storage system including a plurality of servers and a control server that sets storage areas available to one of the plurality of servers from among the storage areas of a plurality of storages sharable among the plurality of servers, the storage control program causing the computer processer to execute a process comprising:
acquiring, for each of the storages, a first index about the distance between the control server and the storage;
acquiring, for each of the storage areas in the storages, a second index about a writing speed to the storage area; and
calculating, for each of the storage areas, a general index indicating the quality of the storage area based on the indexes acquired by acquiring the first index and acquiring the second index.

12. The computer-readable recording medium according to claim 11, the program causing the computer processer to execute the process further comprising:
acquiring, for each of the storage areas in the storages, a third index about the frequency of use of the storage area,
wherein the calculating is calculating, for each of the storage areas, a general index indicating the quality of the storage area based on the indexes acquired by acquiring the first index, acquiring the second index, and acquiring the third index.

13. The computer-readable recording medium according to claim 11, the program causing the computer processer to execute the process further comprising:
determining, for each of the storage areas, whether the free space thereof is greater than or equal to a predetermined free space,
wherein the calculating is calculating a general index indicting the quality of a storage area that may be determined to have a free space greater than or equal to a predetermined free space by the determining.

14. The computer-readable recording medium according to claim 12, the program causing the computer processer to execute the process further comprising:
determining, for each of the storage areas, whether the free space thereof is greater than or equal to a predetermined free space,
wherein the calculating is calculating a general index indicting the quality of a storage area that may be determined to have a free space greater than or equal to a predetermined free space by the determining.

15. The computer-readable recording medium according to claim 11, the program causing the computer processer to execute the process further comprising:
evaluating, for each of the storage areas, quality corresponding to the general index calculated by the calculating.

16. The computer-readable recording medium according to claim 12, the program causing the computer processer to execute the process further comprising:
evaluating, for each of the storage areas, quality corresponding to the general index calculated by the calculating.

17. The computer-readable recording medium according to claim 13, the program causing the computer processer to execute the process further comprising:
evaluating, for each of the storage areas, quality corresponding to the general index calculated by the calculating.

18. The computer-readable recording medium according to claim 15, the program causing the computer processer to execute the process further comprising:
acquiring quality required by a specific server selected from the plurality of servers;
specifying an unassigned storage area of the same quality as the quality acquired by the acquiring based on the quality evaluated by the evaluating; and
assigning the storage area specified by the specifying to the specific server.

19. The computer-readable recording medium according to claim 16, the program causing the computer processer to execute the process further comprising:
acquiring quality required by a specific server selected from the plurality of servers;
specifying an unassigned storage area of the same quality as the quality acquired by the acquiring based on the quality evaluated by the evaluating; and
assigning the storage area specified by the specifying to the specific server.
